(19) United States
(12) Patent Application Publication
(10) Pub. No.: US 2024/0245572 A1
(43) Pub. Date: Jul. 25, 2024

(54) HAND-MOUNTED MASSAGE TOOL AND METHOD OF USE

(71) Applicant: Creative Perspective LLC, Fort Wayne, IN (US)

(72) Inventors: Todd Arnold, Westfield, IN (US); Timothy Drudge, Carmel, IN (US)

(21) Appl. No.: 18/417,607

(22) Filed: Jan. 19, 2024

Related U.S. Application Data
(60) Provisional application No. 63/480,652, filed on Jan. 19, 2023.

(51) Int. Cl. A61H 7/00

(52) U.S. Cl. CPC A61H 7/003; A61H 2201/1638; A61H 2201/1685

(57) ABSTRACT

A hand-mounted massage tool having a hand mount that is releasably mountable about a user's hand and palm in an operative position and a massage instrument that releasably attaches to the hand mount and extends away from the palm when in the operative position. The massage instrument can be used to massage a patient without requiring the user to grasp the massage instrument with their fingers.

### CROSS-REFERENCE TO RELATED APPLICATIONS

This application claims the benefit of U.S. Provisional Patent Application Ser. No. 63/480,652 filed Jan. 19, 2023, the contents of which are incorporated herein by reference.

### BACKGROUND OF THE INVENTION

The invention generally relates to massage tools and their uses, and more particularly to a tool configured to be secured to and manipulated by a hand, preferably a single hand, as a massage tool.

There are many ways to do soft tissue work on the human body. Hands are the most common tool for massaging muscles and joints. Man-made tools (also referred to herein as instruments) have become much more popular and are used by clinicians and end users alike. These tools include various handheld massage instruments such as those available from Graston Technique of Indianapolis, Indiana, HawkGrips of Conshohocken, Pennsylvania, Implus Footcare, LLC of Durham, North Carolina under the brand name RockBlades®, among others. Massage techniques that utilize man-made tools are often referred to as instrument assisted soft tissue mobilization (IASTM). Typically, IASTM techniques include using handheld instruments typically made of stainless steel with various beveled edges and contours that can conform to different body anatomical locations and allows for deeper penetration than possible with only the hands.

IASTM can be employed for the detection and/or treatment of soft tissue problems. In general, a massage tool is used to manipulate those painful areas in muscles that feel like small knots. Such knots are called trigger points and can individually be painful, but they can also make the muscles function abnormally, for example, by incorrectly pulling on tendons and creating pain. Massage tools can also be used directly on tendons and ligaments to treat chronic irritation of these tissues. IASTM techniques are also commonly used on athletes to relax and sooth muscles and enhance performance.

An effect of tools described above is that they need to be gripped with the fingers or the hands of the user (often a clinician but in some cases may be the person undergoing treatment) to keep them in place and apply pressure. For example, if a user wants to apply fifty pounds of pressure, they have to hold on with fifty pounds of grip or the device moves. In addition, many relatively large handheld massage instruments used in IASTM techniques require two hands to hold the tool, making some locations hard to access. After a day of using these types of known instruments, many clinicians have hand and arm pain that cause them to seek out their own treatment. In some cases, the pain can be severe and cause injuries that may reduce the number of years the clinician can practice.

In view of the above, it can be appreciated that clinicians often seek other options to provide massage treatment to others and themselves. For example, some clinicians use cupping, dry needling, or active release techniques. While effective to some degree, it would be desirable to have a massage tool capable of reducing or eliminating the adverse effects of existing handheld massage instruments.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, massage tools configured to be secured to and manipulated by a hand, and to methods of their use.

According to a nonlimiting aspect of the invention, a hand-mounted massage tool includes a hand mount that is releasably mountable about a user's hand and palm in an operative position, and a massage instrument that releasably attaches to the hand mount and extends away from the palm when in the operative position.

According to another nonlimiting aspect of the invention, a method of wearing the hand-mounted massage tool includes releasably mounting the hand mount about a user's hand such that the massage instrument extends away from the user's palm.

Technical aspects of hand-mounted massage tools and their methods of use as described above preferably include the ability to provide a clinician or the personal user the advantage of not having to actively grip the tool with their hand or fingers, but rather take advantage of the larger muscles of the upper extremities and/or full body.

These and other aspects, arrangements, features, and/or technical effects will become apparent upon detailed inspection of the figures and the following description.

### BRIEF DESCRIPTION OF THE DRAWINGS

FIG. 1 is a perspective view of a hand-mounted massage tool worn by a user according to certain non-limiting aspects of the present invention.

FIG. 2 is a perspective view of a hand mount and three detachable massage instruments of the hand-mounted massage tool of FIG. 1.

FIG. 3 is an enlarged partial view of the hand mount of FIG. 2.

FIG. 4 is a plan view representing a backside of one of the massage instruments of FIGS. 1 and 2.

FIG. 5 is a perspective view of the back of the hand mount of FIG. 2 after being partially mounted on a user's hand.

FIG. 6 is a perspective view of the back of the hand mount of FIG. 2 in a fully mounted position on a user's hand.

FIG. 7 is a perspective view of the front of the hand mount of FIG. 2 in a fully mounted position on a user's hand without a detachable instrument attached thereto.

### DETAILED DESCRIPTION OF THE INVENTION

The intended purpose of the following detailed description of the invention and the phraseology and terminology employed therein is to describe what is shown in the drawings, which depict one or more nonlimiting embodiments of the invention, and to describe certain but not all aspects of the embodiment(s) to which the drawings relate. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of a hand-mounted massage tool 10 and its components during use and/or as represented in the drawings. All such relative terms are useful to describe the illustrated embodiment(s) but should not be otherwise interpreted as limiting the scope of the invention.

According to preferred aspects of the invention, the hand-mounted massage tool 10 is configured to be worn on a human hand and held in place with at least one strap that secures the massage tool in place on the hand. The strap(s) is preferably adjustable to fit different-sized hands, and the massage tool includes at least one massage instrument that is disposed on a palm portion thereof so as to be positioned on the palmar surface of the hand to allow pressure to be applied by the massage instrument to at least one selected trigger point or other area of interest during a massage. The palm portion of the massage tool includes at least one attachment receiver to which different shaped massage instruments can be secured and thereby positioned on the palm of the hand to address different muscle and tendon surfaces. The massage instrument itself is preferably smooth and can slide over human skin with or without application of a skin lubricant, for example, cocoa butter or other oil or lotion commonly used with massage tools.

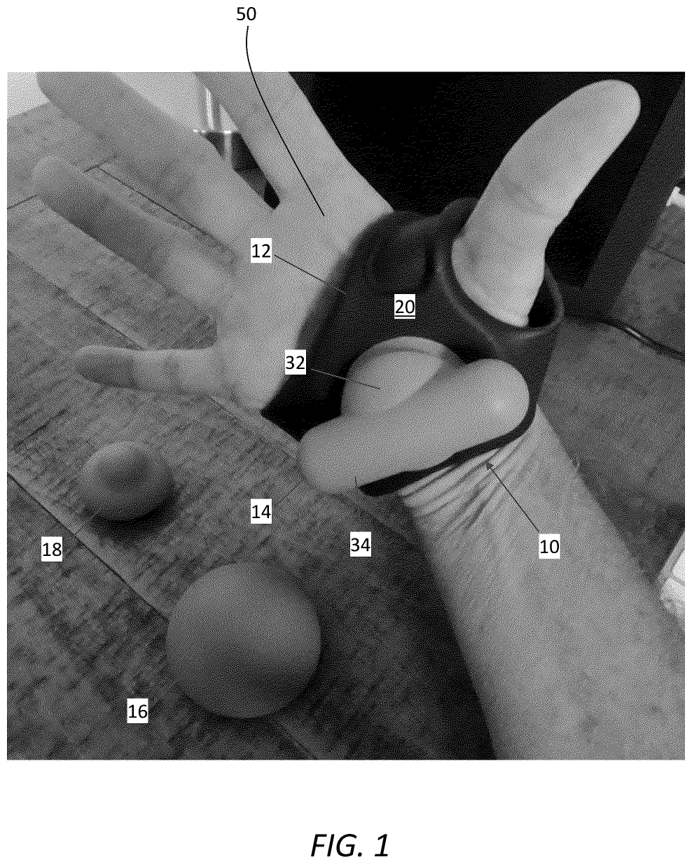

Turning now to the drawings, FIG. 1 illustrates a hand-mounted massage tool 10 shown in its operative position when worn on the hand 50 of a human user, such as a clinician treating a patient or a patient treating themself. The hand-mounted massage tool 10 includes a hand mount 12 with a first type of detachable massage instrument 14 releasably attached thereto. Two other types of detachable massage instruments 16 and 18 that may alternatively be releasably attached to the hand mount 12 are also shown in FIG. 1. The detachable massage instruments 14, 16, and 18 that can be releasably attached to and used with the hand mount 12 are not limited to only these three types and styles of instruments, but rather other types of massage instruments could be adapted for releasable attachment to the hand mount 12 and used for massaging a patient. The hand mount 12 is configured to be releasably mounted onto a user's hand 50 such that the hand-mounted massage tool 10 is worn on the user's hand 50 and against the user's palm in an operative position for use during a massage treatment. As will become evident from the following discussion, any one of the detachable massage instruments 14, 16, and 18 may be releasably attached to the hand mount 12 for use and subsequently detached from the hand mount 12 to allow a different detachable massage instrument 14, 16, or 18 to be releasably attached to the hand mount 12. As shown in FIG. 1, when mounted and worn on the user's hand 50 in the operative position, a massage instrument (e.g., 14) mounted thereto is disposed so as to extend away from the user's palm. In this configuration, the user can massage a patient (or oneself) by placing the massage instrument 14 against the skin of the patient and pressing with the palm without having to grasp and hold on the massage instrument 14 with the user's fingers. This preferably allows the user to more easily apply pressure to muscles of interest with the stronger muscles of the arm and/or upper body without tiring the user's finger muscles.

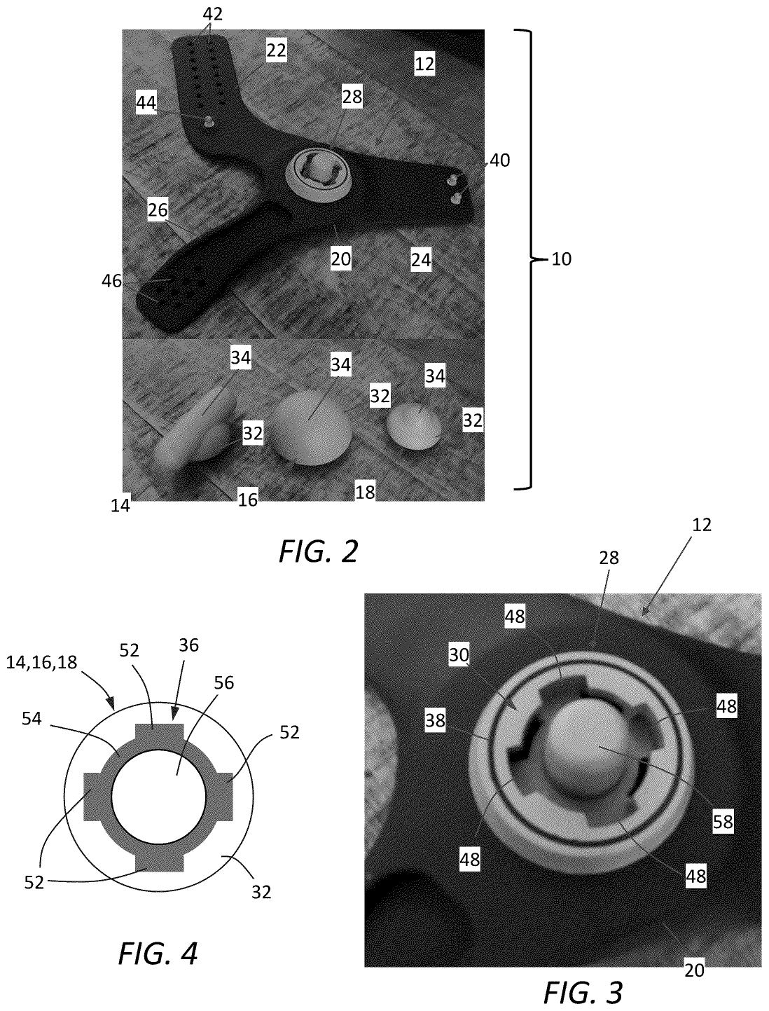

As best seen in FIG. 2, the hand mount 12 has a palm section 20, a first wrist strap 22 extending in a first direction from the palm section 20, a second wrist strap 24 extending in a second direction from the palm section 20 approximately opposite the first direction, and a thumb strap 26 extending from the palm section 20 in a third direction that is different from the first and second directions. The hand mount 12 is preferably constructed of a flexible material that is preferably strong enough to provide structural support for the massage tool 10 and its massage instruments 14, 16, and 18 during operative use to massage a patient (or oneself) when worn on the hand in the operative position. The flexible material is also preferably biocompatible to human skin, as well as being dishwasher safe. Notable but nonlimiting examples of such materials for the hand mount 12 include synthetic or natural rubber, silicone rubber, a flexible plastic, and/or similar materials.

As best seen in FIGS. 2 and 3, an attachment receiver 28 is disposed on a front side of the palm section 20 of the massage tool 10. The attachment receiver 28 is configured to releasably receive any one of the detachable massage instruments 14, 16, and 18. Preferably, the attachment receiver 28 also includes a locking mechanism 30 to lock the selected massage instrument 14, 16, or 18 into the attachment receiver 28 until the user chooses to remove the instrument 14, 16, or 18 by releasing the instrument 14, 16, or 18 from the locking mechanism 30, for example, to remove the massage instrument 14 and attach a different massage instrument 16 or 18. The nonlimiting embodiment of the locking mechanism 30 represented in FIG. 3 includes a bayonet coupling having one or more notches or slots 48 configured to individually receive a corresponding number of locking tabs 52 of the massage instruments 14, 16, and 18. The tabs 52 are represented in FIG. 4 as being carried on the backside of the massage instruments 14, 16, and 18, in other words, opposite a prominence on each instrument 14, 16, and 18 that defines a massage portion 34 on a front side of the corresponding instrument 14, 16, and 18. The locking mechanism 30 and tabs 52 enable each of the massage instruments 14, 16, and 18 to be easily locked and unlocked into the attachment receiver 28 by twisting the massage instrument 14, 16, or 18 within the receiver 28 in a locking (e.g., clockwise) direction to secure the instrument 14, 16, or 18 to the receiver 28 and an unlocking (e.g., counterclockwise) direction to unlock and release the massage instrument 14, 16, or 18 from the receiver 28. FIG. 4 represents the tabs 52 of the massage instrument 14, 16, or 18 as radially projecting from a ring-shaped rim 54 that protrudes from a base section 32 of the instrument 14, 16, or 18 and defines a central cavity 56 in the backside of the instrument 14, 16, or 18 that is sized to receive a central protrusion 58 protruding from the receiver 28. In combination, the tabs 52, rim 54, and cavity 56 define portions of a locking mechanism 36 of the instrument 14, 16, and 18 that is complementary to the locking mechanism 30 of the attachment receiver 28.

The massage portion 34 of each instrument 14, 16, and 18 is disposed on the side of the base section 32 opposite the locking mechanism 36 so that the massage portion 34 will project away from the user's palm when the massage instrument 14, 16, or 18 is attached to the attachment receiver 30 with the locking mechanisms 30 and 36. In the first massage instrument 14, the massage portion 34 has a generally cylindrical shape that extends transversely to its base portion 32, emulating a “roll of coins.” In the second massage instrument 16, the base portion 32 and massage portion 34 are integrated to define a large bulbous semispherical shape, such as half a ball or a mushroom head, which extends away from the base portion 32. In the third massage instrument 18, the massage portion 34 has a smaller knob shape that is distinct from the base portion 32 and protrudes from the base portion 32 so as to be capable of directing pressure to a smaller area, such a small muscle knot, than the larger bulbous shape of the second massage instrument 16. As previously explained, the massage portion 34 may have any of a near infinite number of different shapes as desired for various specific massage applications.

FIG. 3 represents the attachment receiver 28 as further comprising a seal 38 disposed between the base of the receiver 28 and the base portion 32 of the massage instrument 14, 16, or 18 attached thereto that surrounds the locking mechanism 30 to prevent lotion or other liquid from getting into the locking mechanism 30. In this example, the seal 38 is formed by a silicone ring disposed on and carried by the base of the attachment receiver 28, and surrounds the locking mechanism 30 so as to form a liquid resistant seal against the opposing face of the base section 32 of the massage instrument 14, 16, or 18 when attached as previously described. The seal 38 could be formed by other arrangements, for example, by having the silicone ring carried by the base portion 32 of the massage instrument 14, 16, or 18. The silicone ring or other type of resilient seal 38 may also provide a snugger fit that may help keep the massage instrument 14, 16, or 18 locked in place on the attachment receiver 28.

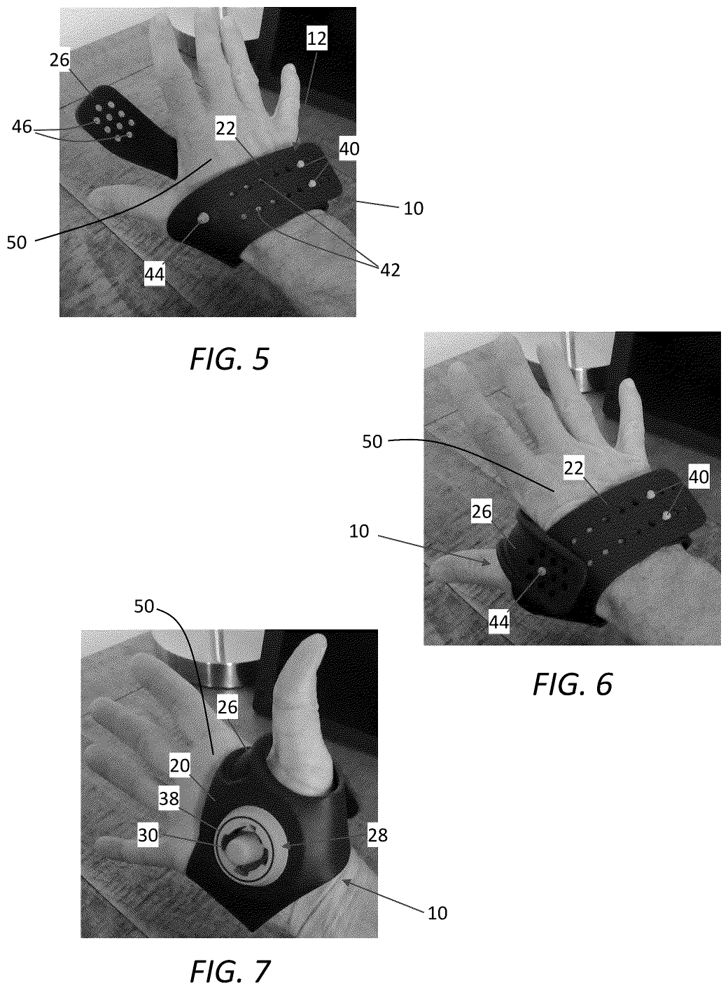

Turning now to FIGS. 5-7, to mount the hand mount 12 onto a user's hand 50 so as to wear the hand mount 12 in its operative position, the palm section 20 is placed against the palm of the user's hand 50 with the attachment receiver 28 facing away from the user's palm. The first wrist strap 22 is wrapped around the user's wrist in one direction, and the second wrist strap 24 is wrapped around the user's wrist in the opposite direction, such that the distal end of the first wrist strap 22 overlies the distal end of the second wrist strap 24 and, together, the first and second wrist straps 22 and 24 completely surround the user's wrist. The first and second wrist straps 22 and 24 are then fastened together with one or more first fasteners. In this example, the fasteners include a pair of pegs 40 disposed near the distal end of the second wrist strap 24 that resiliently lock into a complementary pair of holes 42 disposed in the first wrist strap 22, as best seen in FIG. 5. Multiple such pairs of holes 42 are disposed along the length of the first wrist strap 22 such that the wrist straps 22 and 24 may be fastened together to encircle different sized wrists. Other types of fastening systems, such as snaps, hook and loop fasteners, hooks, and/or buttons, may be used for the fasteners as well as different numbers of fasteners.

As represented in FIG. 6, the thumb strap 26 can then be wrapped around the hand 50 in the gap between the thumb and index finger so that its distal end overlaps a medial portion of the first wrist strap 22 and then fastened to the first wrist strap 22 by a second fastener, which in this example also includes a peg 44 extending from the medial area of the first wrist strap 22 that resiliently locks into any of a plurality of corresponding holes 46 located in the distal end of the thumb strap 26. The second fastener for the thumb strap 26 may also take other forms as already suggested relative to the first fastener.

The materials from which the hand-mounted massage tool 10 is made are preferably relatively inexpensive (especially compared to typical stainless steel massage tools), such as flexible silicone rubber and/or hard plastics, which may allow more people access to the massage tool 10 for self-treatment. Preferably, the materials from which the massage tool 10 is constructed are chemical and temperature resistant, therefore the standard creams and lotions used during massage sessions will not change the material or its properties. The entire tool 10 is preferably dishwasher safe so that the tool 10 and its components can be easily cleaned, for example, in a common household dishwasher. The price point for some of those other named tools are in the thousands of dollars and therefore take individual consumers out of the market. The materials should allow more people access to the tool 10 for self-treatment.

As previously noted above, though the foregoing detailed description describes certain aspects of one or more particular embodiments of the invention, alternatives could be adopted by one skilled in the art. For example, the hand-mounted massage tool 10 and is components could differ in appearance and construction from the embodiments described herein and shown in the drawings, functions of certain components of the massage tool 10 could be performed by components of different construction but capable of a similar (though not necessarily equivalent) function, and various materials could be used in the fabrication of the massage tool 10 and/or its components. As such, and again as was previously noted, it should be understood that the invention is not necessarily limited to any particular embodiment described herein or illustrated in the drawings.

1. A hand-mounted massage tool comprising:
a hand mount that is releasably mountable about a user's hand and palm in an operative position; and
a massage instrument that releasably attaches to the hand mount and extends away from the palm when in the operative position.

2. The hand-mounted massage tool of claim 1, wherein the hand mount comprises:
a palm section sized and shaped to fit into the palm of a user in the operative position; and
an attachment receiver carried by the palm section;
wherein the massage instrument releasably attaches to the attachment receiver.

3. The hand-mounted massage tool of claim 1, wherein the hand mount comprises:
a first wrist strap extending from the palm section in a first direction; and
a second wrist strap extending from the palm section in a second direction;
wherein a distal end of the first wrist strap releasably fastens a distal end of the second wrist strap.

4. The hand-mounted massage tool of claim 1, wherein the hand mount comprises:
and a thumb strap extending from the palm section in a third direction;
wherein a distal end of the thumb strap releasably fastens to a medial area of the first wrist strap.

5. The hand-mounted massage tool of claim 1, wherein the massage instrument releasably locks to the attachment receiver.

6. The hand-mounted massage tool of claim 1, wherein the attachment receiver comprises a first locking mechanism that couples with a second locking mechanism carried by the massage instrument.

7. The hand-mounted massage tool of claim 1, wherein the first locking mechanism comprises a bayonet connection.

8. The hand-mounted massage tool of claim 1, wherein the massage instrument comprises a base section and massage portion, wherein the base portion comprises the second locking mechanism, and wherein the massage portion is disposed on an opposite side of the base section from the second locking mechanism.

9. The hand-mounted massage tool of claim 1, wherein the massage portion has at least one of a cylindrical shape, a bulbous shape, and a knob shape.

10. A method of wearing the hand-mounted massage tool of claim 1 in an operative position, the method comprising releasably mounting the hand mount about a user's hand such that the massage instrument extends away from the user's palm.
